(19) United States
(12) Patent Application Publication
(10) Pub. No.: US 2013/0011652 A1
(43) Pub. Date: Jan. 10, 2013

(54) PAPER MACHINE CLOTHING HAVING MONOFILAMENTS WITH NANO-GRAPHENE PLATELETS

(76) Inventors: Jürgen Abraham, Nattheim (DE); Ashish Sen, Summerville, SC (US); Brian Good, Summerville, SC (US)

(21) Appl. No.: 13/177,117

(22) Filed: Jul. 6, 2011

(51) Int. Cl. D03D 15/00; C08K 3/04; D01D 5/12; D02G 3/04; C08L 67/02; B82Y 30/00

(52) U.S. Cl. 428/221; 442/181; 428/401; 524/605; 264/210.8; 977/753

(57) ABSTRACT

A paper machine clothing (PMC) fabric includes a plurality of monofilament yarns. At least some of the yarns have a composition which is a mixture of between 90% to 99.8% thermoplastic resin, and between 0.2% to 10% nano-graphene. The thermoplastic resin is preferably polyethylene terephthalate (PET).

### BACKGROUND OF THE INVENTION

1. Field of the Invention

The present invention relates to paper machine clothing, and, more particularly, to the composition of monofilaments used in paper machine clothing.

2. Description of the Related Art

A paper machine clothing (PMC) fabric is typically carried by a number of rolls in a paper machine, and travels at a high speed. Vacuum boxes are used to pull moisture from the web through the PMC. This creates multiple friction points within the paper machine that wears down the PMC fabric and increases power consumption. The individual yarns making up a PMC fabric require several desirable physical properties, such as modulus of elasticity, relative elongation, abrasion resistance, fibrillation resistance, and a low coefficient of friction.

Graphene is an allotrope of carbon, whose structure is one-atom-thick planar sheets of sp²-bonded carbon atoms that are densely packed in a honeycomb crystal lattice. Graphene is most easily visualized as an atomic-scale chicken wire made of carbon atoms and their bonds. Graphene sheets stack to form graphite with an interplanar spacing of 0.335 nm, which means that a stack of 3 million sheets would be only one millimeter thick. Graphene is the basic structural element of some carbon allotropes including graphite, charcoal, carbon nanotubes (CNTs) and fullerenes.

CNTs are nanometer-scale sized tube-shaped molecules having the structure of a graphite molecule rolled into a tube. A nanotube can be single-walled or multi-walled, dependent upon conditions of preparation. Carbon nanotubes typically are electrically conductive and mechanically strong and stiff along their length. Nanotubes typically also have a relatively high aspect ratio (length/diameter ratio). Due to these properties, the use of CNTs as reinforcements in composite materials for both structural and functional applications would be advantageous.

Instead of trying to develop much lower-cost processes for making CNTs, researchers have worked diligently to develop alternative nano-scaled carbon materials that exhibit comparable properties. This development work has led to the discovery of processes for producing individual nano-scaled graphite planes (individual graphene sheets) and stacks of multiple nano-scaled graphene sheets, which are collectively called nano-sized graphene plates (NGPs). The structures of these materials may be best visualized by making a longitudinal scission on the single-wall or multi-wall of a nano-tube along its tube axis direction and then flattening the resulting sheet or plate. In practice, NGPs are obtained from a precursor material, such as minute graphite particles, using a low-cost process, but not via flattening of CNTs. These nano materials could potentially become cost-effective substitutes for CNTs or other types of nano-rods for various scientific and engineering applications.

Recently, many researchers are looking into NGPs for aerospace, automotive, energy, electronics, constructions, medical and telecommunications applications. This new material demonstrates the highest thermal conductivity known today. NGPs also provide electrical conductivity similar to copper yet the material's density is four times lower. NGPs are fifty times stronger than steel with a surface area twice that of carbon nanotubes. NGPs have an ultra high Young's modulus of elasticity and exceptionally high strength. In addition to high in-plane electrical conductivity, NGPs also have outstanding thermal conductivity.

Graphene is produced by a thermal exfoliation process from graphite. This process results in a rough and wrinkled surface texture due to a high level of surface defects. These uneven surfaces unite together with the surrounding polymer material and increase the load sharing between the graphene and the polymer material. Because of the large surface area, both the top and bottom surfaces of the graphene sheet can be in close contact with the polymer matrix.

What is needed in the art is a PET monofilament yarn for a PMC fabric that has an improved abrasion resistance and thermal conductivity.

### SUMMARY OF THE INVENTION

The present invention provides a PMC with NGP reinforced monofilaments with an increased modulus, less creep, improved stiffness, and increased abrasion resistance. Graphene, an atom-thick sheet of carbon atoms that can organize like a nano-scale boundary, can help in the development of next-generation nano-composite materials. Graphene-based polymer composites benefit from graphene's excellent thermal, mechanical and electrical properties.

The invention in one form is directed to a PMC fabric including a plurality of monofilament yarns. At least some of the yarns have a composition which is a mixture of between 90% to 99.8% thermoplastic resin, and between 0.2% to 10% nano-graphene.

The invention in another form is directed to a PMC fabric yarn for use in a PMC fabric. The PMC yarn has a composition which is a mixture of between 90% to 99.8% thermoplastic resin, and between 0.2% to 10% nano-graphene.

The invention in yet another form is directed to a method of manufacturing a PMC fabric yarn for use in a PMC fabric. The method includes the steps of: melt blending a mixture of between 90% to 99.8% thermoplastic resin, and between 0.2% to 10% nano-graphene; spinning the mixture into a filament; and drawing the filament into a monofilament PMC fabric yarn with at least one predetermined physical property.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a fragmentary, perspective view of a portion of a fabric including an embodiment of a monofilament yarn of the present invention;

FIG. 2 is an enlarged, fragmentary, perspective view of a portion of a single monofilament yarn in the fabric of FIG. 1, illustrating nano-graphene embedded within the yarn; and

FIG. 3 is a flowchart illustrating an embodiment of the method of making monofilament yarns of the present invention.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

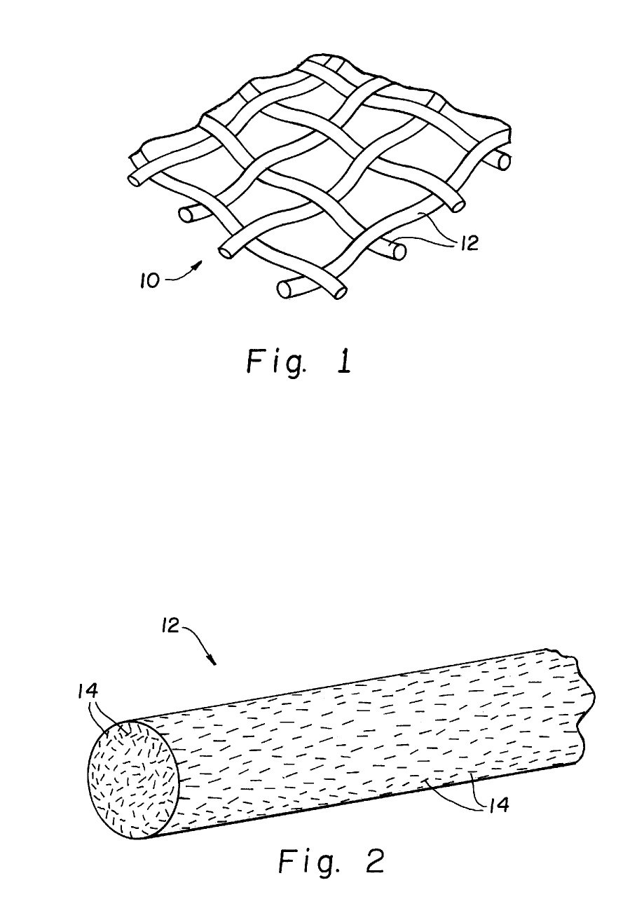

Referring now to the drawings, and more particularly to FIG. 1, there is shown a portion of an embodiment of a PMC fabric 10 including a plurality of woven monofilament yarns 12. Yarns 12 have a diameter of between approximately 0.05 mm and 0.9 mm, but this may vary between applications. The specific configuration of fabric 10 may vary, depending upon the application. For example, the specific weave pattern of fabric 10 may vary from one application to another. Moreover, fabric 10 need not necessarily be a woven fabric, but may include non-woven yarns 12.

At least some of the yarns 12 making up fabric 10 have a composition which is a mixture of between 90% to 99.8% thermoplastic resin, and between 0.2% to 10% nano-graphene. In a preferred embodiment, the thermoplastic resin is comprised of PET. Yarns 12 have a diameter of between approximately 0.05 mm and 0.9 mm, and in one embodiment are approximately 0.18 mm.

Referring now to FIG. 2, a yarn 12 is shown in greater detail, and includes nano-graphene 14 embedded within the PET base material. Yarn 12 may be formed in one embodiment with a drawing process, which causes the nano-graphene 14 to be generally aligned in a longitudinal direction of yarn 12. Nano-graphene 14 may also be substantially uniformly distributed throughout the cross section of yarn 12, for some applications.

### Example 1

A small sample of NGP (in this example, manufactured by Angstron Materials, Dayton, OH, USA) was used to compare the properties of PET and PET-NGP monofilament yarns. An 8% masterbatch PET-NGP was compounded using a screw extruder. The dispersion quality of the nano-graphene in the masterbatch was determined by using a filtration step and measuring the thermal conductivity of the pellets. The PET-NGP masterbatch was filtered through a 500 mesh (30 micron) screen and the screen pack pressure remained stable, thus indicating the PET-NGP masterbatch was well dispersed. In addition, the thermal conductivity of PET with 8% NGP is about 75% higher than PET. Table 1 shows the thermal conductivity values for PET pellets and PET-NGP (8 wt % loading) pellets.

TABLE 1
Comparison of thermal conductivity properties of
PET and PET-NGP pellets

| | Thermal Conductivity |
|---|---|
| Sample | [W/mK] |
| Polyester (PET) resin | 0.277 |
| PET + NGP (8% loading) | 0.482 |

The PET-NGP masterbatch was used to spin monofilament yarns (0.18 mm) with a final NGP level of 0.8 weight percent (wt %). The properties of PET and PET-NGP yams are shown in Table 2. The control sample is made of 100 percent PET and the PET-NGP yam with 0.8% NGP was made using an 8% PET-NGP masterbatch. The modulus, shrink force and abrasion values for the PET-NGP monofilaments are higher than the PET control sample. The shrinkage and elongation of PET-NGP yarns are lower than that of the PET control sample. The PET-NGP yarn contains about 9.2% of extruded PET resin with a low intrinsic viscosity (IV), due to compounding, whereas the control PET sample does not contain any low IV PET resin. The tenacity values of these yarns are comparable notwithstanding a significant amount of low IV PET material in the PET-NGP yams.

TABLE 2
Properties of PET-NGP Yarns

| | Tenac- | Elon- | Modu- | | Shrink- | Abra- |
|---|---|---|---|---|---|---|
| | ity (gm/ | gation | lus (gm/ | Shrink | age | sion |
| | den) | (%) | den) | Force | 175 C. | Cycles |
| Control | 6.1 | 13.1 | 140.5 | 189.0 | 15.6 | 4040 |
| (100% PET) | | | | | | |
| PET- | 6.1 | 11.8 | 145.2 | 196.0 | 13.7 | 4129 |
| Graphene | | | | | | |
| (0.8% CNT) | | | | | | |

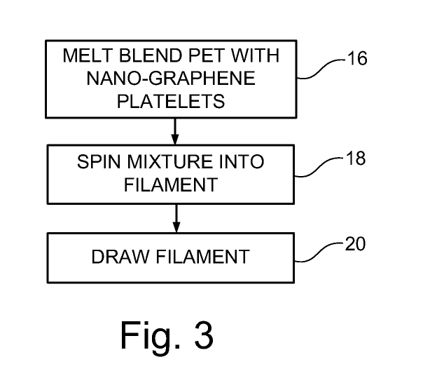

During the manufacture of PMC fabric 10, a screw extruder is used to melt blend a mixture of between 90% to 99.8% thermoplastic resin (preferably PET), and between 0.2% to 10% nano-graphene. (FIG. 3, block 16). The mixture is then spun into a filament (block 18). The filament is then subsequently drawn into a monofilament PMC fabric yarn with at least one predetermined physical property (block 20).

While this invention has been described with respect to at least two embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A paper machine clothing (PMC) fabric including a plurality of monofilament yarns, at least some of said yarns having a composition which is a mixture of between 90% to 99.8% thermoplastic resin, and between 0.2% to 10% nano-graphene.

2. The PMC fabric of claim 1, wherein said thermoplastic resin is comprised of polyethylene terephthalate (PET).

3. The PMC fabric of claim 2, wherein said composition has a modulus of elasticity and an abrasion resistance which are each higher than said PET alone.

4. The PMC fabric of claim 2, wherein said composition has an elongation which is less than said PET alone.

5. The PMC fabric of claim 2, wherein said composition has a tenacity which is approximately the same as said PET alone.

6. The PMC fabric of claim 2, wherein said composition has a thermal conductivity which is higher than said PET alone.

7. The PMC fabric of claim 6, wherein said composition has a thermal conductivity which is about 75% higher than said PET alone.

8. The PMC fabric of claim 1, wherein said composition is a mixture with approximately 0.8% nano-graphene by weight.

9. The PMC fabric of claim 1, wherein said yarns have a diameter of between approximately 0.05 mm and 0.9 mm.

10. The PMC fabric of claim 1, wherein said yarns have a diameter of approximately 0.18 mm.

11. The PMC fabric of claim 1, wherein said PMC fabric includes a plurality of woven yarns.

12. A paper machine clothing (PMC) fabric yarn for use in a PMC fabric, said PMC yarn having a composition which is a mixture of between 90% to 99.8% thermoplastic resin, and between 0.2% to 10% nano-graphene.

13. The PMC fabric yarn of claim 12, wherein said thermoplastic resin is comprised of polyethylene terephthalate (PET).

14. The PMC fabric yarn of claim 13, wherein said composition has a modulus of elasticity and an abrasion resistance which are each higher than said PET alone.

15. The PMC fabric yarn of claim 13, wherein said composition has an elongation which is less than said PET alone.

16. The PMC fabric yarn of claim 13, wherein said composition has a tenacity which is approximately the same as said PET alone.

17. The PMC fabric yarn of claim 13, wherein said composition has a thermal conductivity which is higher than said PET alone.

18. The PMC fabric yarn of claim 17, wherein said composition has a thermal conductivity which is about 75% higher than said PET alone.

19. The PMC fabric yarn of claim 12, wherein said yarns have a diameter of between approximately 0.05 mm and 0.9 mm.

20. A method of manufacturing a paper machine clothing (PMC) fabric yarn for use in a PMC fabric, said method comprising the steps of:
melt blending a mixture of between 90% to 99.8% thermoplastic resin, and between 0.2% to 10% nano-graphene;
spinning the mixture into a filament; and
drawing the filament into a monofilament PMC fabric yarn with at least one predetermined physical property.

21. The method of manufacturing a PMC fabric yarn of claim 20, wherein said thermoplastic resin is comprised of polyethylene terephthalate (PET).

22. The method of manufacturing a PMC fabric yarn of claim 21, wherein said mixture has a modulus of elasticity and an abrasion resistance which are each higher than said PET alone.

23. The method of manufacturing a PMC fabric yarn of claim 21, wherein said mixture has an elongation which is less than said PET alone.

24. The method of manufacturing a PMC fabric yarn of claim 21, wherein said mixture has a thermal conductivity which is higher than said PET alone.

25. The method of manufacturing a PMC fabric yarn of claim 24, wherein said mixture has a thermal conductivity which is about 75% higher than said PET alone.
